(19) United States
(12) Patent Application Publication
(10) Pub. No.: US 2024/0403117 A1
(43) Pub. Date: Dec. 5, 2024

(54) METHOD, SYSTEM, AND STORAGE MEDIUM OF MACHINE-LEARNINGBASED REAL-TIME TASK SCHEDULING FOR APACHE STORM CLUSTER

(71) Applicant: Intelligent Fusion Technology, Inc., Germantown, MD (US)

(72) Inventors: Qi ZHAO, Germantown, MD (US); Genshe CHEN, Germantown, MD (US); Khanh PHAM, Kirtland AFB, NM (US); Erik BLASCH, Arlington, VA (US)

(21) Appl. No.: 18/806,392

(22) Filed: Aug. 15, 2024

Related U.S. Application Data
(63) Continuation-in-part of application No. 17/551,436, filed on Dec. 15, 2021, now Pat. No. 12,067,766.

(51) Int. Cl. G06F 9/48; G06F 9/54; G06N 20/00

(52) U.S. Cl. CPC G06F 9/4881; G06F 9/541; G06N 20/00

(57) ABSTRACT

The present disclosure provides a machine-learning-based real-time task scheduling method. The method includes, for a worker node, executing a training task distributed by a master node; collecting latency time lengths of each machine learning model under different CPU utilization and memory usage; calculating a mean squared error of the latency time lengths of each machine learning model; comparing machine learning models according to mean squared errors of latency time lengths to select a desirable machine learning model installing on the worker node; providing an API for the worker node; when receiving a task by the master node, requesting the worker node to predict a latency time length; and returning the predicted latency time length to the master node; and after the master node collects predicted latency time lengths of worker nodes, assigning the task to a corresponding worker node with a lowest predicted latency time length.

### CROSS-REFERENCE TO RELATED APPLICATION

This application is a continuation-in-part of application Ser. No. 17/551,436, filed on Dec. 15, 2021, the entire contents of which is incorporated herein by reference.

### GOVERNMENT RIGHTS

The present disclosure was made with Government support under Contract No. W51701-22-C-0058, awarded by the United States Army. The U.S. Government has certain rights in the present disclosure.

### FIELD OF THE DISCLOSURE

The present disclosure generally relates to the field of machine learning technology and, more particularly, relates to a method, a system, and a storage medium of machine-learning-based real-time task scheduling for an Apache Storm cluster.

### BACKGROUND

Recently, the adoption of distributed systems has been risen remarkably, primarily due to their ability to enable efficient and flexible collaboration among computers, Internet of Things (IoT) devices, and mobile devices. As the number of devices in these distributed systems continues to surge, the volume of data generated has reached unprecedented heights. Big data analysis, for instance, frequently involves processing millions of data points or continuous data streams. Such applications demand rapid processing within constrained resource environments. Distributed systems offer vast computing capabilities to meet soaring demand for computing resources, thereby rendering these systems invaluable for modern data-driven applications.

The heterogeneity of devices in distributed systems poses significant challenges for effective system design, particularly in task scheduling and resource allocation areas. Devices exhibit diverse operational characteristics and capabilities (leads to varying resource requirements across applications) with certain prioritizing memory usage while others demanding more CPU resources. Apache Storm, a prominent platform employed in such distributed environments, offers scheduling options like default round-robin scheduler and a resource-aware scheduler. However, these schedulers primarily operate under the assumption of a homogeneous computing environment, which may diminish the effectiveness in heterogeneous systems where the disparity in device capabilities can result in sub-optimal resource utilization and inefficient task distribution.

The mismatch between homogeneous assumptions of existing schedulers and the heterogeneous nature of modern distributed systems necessitates the development of more sophisticated scheduling schemes (methods or algorithms). The schemes must intelligently consider the unique characteristics and resource profiles of each device in the system, which may ensure that tasks are allocated in a manner that maximizes overall system performance and efficiency. Addressing such challenge is crucial for leveraging full potential of heterogeneous distributed systems and enabling efficient resource utilization across diverse device capabilities.

### BRIEF SUMMARY OF THE DISCLOSURE

One aspect of the present disclosure provides a machine-learning-based real-time task scheduling method, applied to an Apache Storm cluster, where the Apache Storm cluster includes a master node and a plurality of worker nodes. The method includes, for a worker node of the plurality of worker nodes, executing a training task distributed by the master node; collecting latency time lengths of each of a plurality of machine learning models under different CPU (central processing unit) utilization and memory usage; calculating a mean squared error of the latency time lengths of each of the plurality of machine learning models; comparing the plurality of machine learning models according to mean squared errors of latency time lengths corresponding to the plurality of machine learning models to select a desirable machine learning model; and installing the desirable machine learning model on the worker node; providing an API (application programming interface) for the worker node configured for communication between the master node and the worker node; when receiving a task by the master node, requesting the worker node to predict a latency time length according to current CPU utilization and current memory usage of the worker node; and returning the predicted latency time length to the master via the API of the worker node; and after the master node collects predicted latency time lengths of the plurality of worker nodes, assigning the task to a corresponding worker node with a lowest predicted latency time length.

Another aspect of the present disclosure provides an ionosphere estimation system. The system includes a memory, configured to store program instructions for performing a machine-learning-based real-time task scheduling method, applied to an Apache Storm cluster, where the Apache Storm cluster includes a master node and a plurality of worker nodes; and a processor, coupled with the memory and, when executing the program instructions, configured for: for a worker node of the plurality of worker nodes, executing a training task distributed by the master node; collecting latency time lengths of each of a plurality of machine learning models under different CPU (central processing unit) utilization and memory usage; calculating a mean squared error of the latency time lengths of each of the plurality of machine learning models; comparing the plurality of machine learning models according to mean squared errors of latency time lengths corresponding to the plurality of machine learning models to select a desirable machine learning model; and installing the desirable machine learning model on the worker node; providing an API (application programming interface) for the worker node configured for communication between the master node and the worker node; when receiving a task by the master node, requesting the worker node to predict a latency time length according to current CPU utilization and current memory usage of the worker node; and returning the predicted latency time length to the master via the API of the worker node; and after the master node collects predicted latency time lengths of the plurality of worker nodes, assigning the task to a corresponding worker node with a lowest predicted latency time length.

Another aspect of the present disclosure provides a non-transitory computer-readable storage medium, containing program instructions for, when being executed by a processor, performing a machine-learning-based real-time task scheduling method, applied to an Apache Storm cluster, where the Apache Storm cluster includes a master node and a plurality of worker nodes. The method includes, for a worker node of the plurality of worker nodes, executing a training task distributed by the master node; collecting latency time lengths of each of a plurality of machine learning models under different CPU (central processing unit) utilization and memory usage; calculating a mean squared error of the latency time lengths of each of the plurality of machine learning models; comparing the plurality of machine learning models according to mean squared errors of latency time lengths corresponding to the plurality of machine learning models to select a desirable machine learning model; and installing the desirable machine learning model on the worker node; providing an API (application programming interface) for the worker node configured for communication between the master node and the worker node; when receiving a task by the master node, requesting the worker node to predict a latency time length according to current CPU utilization and current memory usage of the worker node; and returning the predicted latency time length to the master via the API of the worker node; and after the master node collects predicted latency time lengths of the plurality of worker nodes, assigning the task to a corresponding worker node with a lowest predicted latency time length.

Other aspects of the present disclosure may be understood by those skilled in the art in light of the description, the claims, and the drawings of the present disclosure.

### BRIEF DESCRIPTION OF THE DRAWINGS

The accompanying drawings, which are incorporated into a part of the specification, illustrate embodiments of the present disclosure and together with the description to explain the principles of the present disclosure.

FIG. 1 depicts an exemplary an exemplary machine-learning-based real-time task scheduling method according to various disclosed embodiments of the present disclosure.

FIG. 2 depicts a schematic of an exemplary structure of Apache Storm framework according to various disclosed embodiments of the present disclosure.

FIG. 3 depicts a schematic of a serial topology and a parallel topology according to various disclosed embodiments of the present disclosure.

FIG. 4 depicts a schematic of comparison of mean squared errors of three models according to various disclosed embodiments of the present disclosure.

FIG. 5 depicts a screenshot of an exemplary RESTful API implementation according to various disclosed embodiments of the present disclosure.

FIG. 6 depicts an exemplary schematic of task amount for each worker node according to various disclosed embodiments of the present disclosure.

FIG. 7 depicts an exemplary schematic of quartiles express latency distribution according to various disclosed embodiments of the present disclosure.

FIG. 8 depicts an exemplary schematic of average latency for two schedulers according to various disclosed embodiments of the present disclosure.

### DETAILED DESCRIPTION

References may be made in detail to exemplary embodiments of the disclosure, which may be illustrated in the accompanying drawings. Wherever possible, same reference numbers may be used throughout the accompanying drawings to refer to same or similar parts.

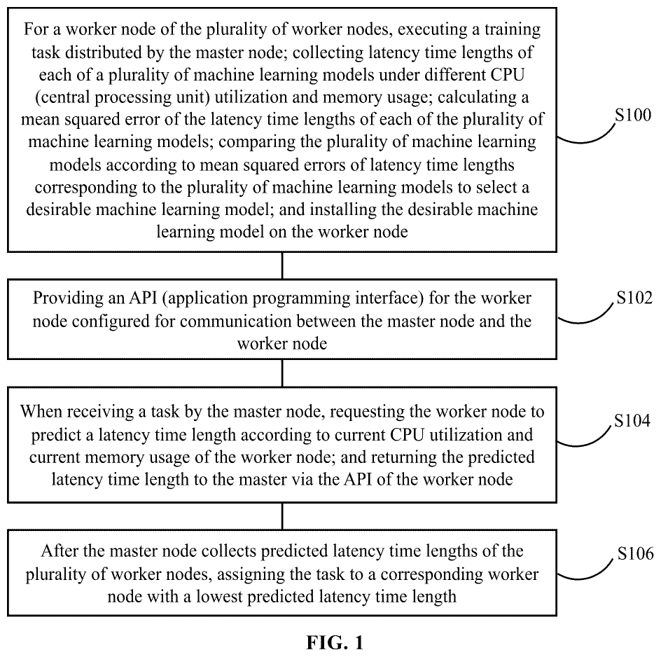

According to various embodiments of the present disclosure, a machine-learning-based real-time task scheduling method, applied to an Apache Storm cluster, where the Apache Storm cluster includes a master node and a plurality of worker nodes, is described in detail hereinafter. FIG. 1 depicts an exemplary an exemplary machine-learning-based real-time task scheduling method according to various disclosed embodiments of the present disclosure. Referring to FIG. 1, the machine-learning-based real-time task scheduling method includes following exemplary steps.

At S100, for a worker node of the plurality of worker nodes, a training task distributed by the master node is executed; latency time lengths of each of a plurality of machine learning models under different CPU (central processing unit) utilization and memory usage are collected; a mean squared error of the latency time lengths of each of the plurality of machine learning models is calculated; the plurality of machine learning models is compared according to mean squared errors of latency time lengths corresponding to the plurality of machine learning models to select a desirable machine learning model; and the desirable machine learning model is installed on the worker node.

At S102, an API (application programming interface) is provided for the worker node configured for communication between the master node and the worker node.

At S104, when receiving a task by the master node, the worker node is requested to predict a latency time length according to current CPU utilization and current memory usage of the worker node; and the predicted latency time length is returned to the master via the API of the worker node.

At S106, after the master node collects predicted latency time lengths of the plurality of worker nodes, the task is assigned to a corresponding worker node with a lowest predicted latency time length.

In one embodiment, the latency time length is an average frame processing time in a minute.

In one embodiment, the plurality of machine learning models includes Long Short-Term Memory (LSTM), Convolutional Neural Networks (CNN), and Deep Belief Networks (DBN).

In one embodiment, the training task includes one of objection detection, location tracking, event tagging, target navigation, and model reconstruction.

In one embodiment, the worker node manages one or more worker processes capable of running a plurality of tasks in parallel.

In one embodiment, the Apache Storm cluster is a heterogeneous distributed stream processing system.

Apache Storm is a popular open-source distributed computing platform for real-time stream data processing. However, existing task scheduling methods for Apache Storm do not adequately consider the heterogeneity and dynamics of node computing resources and task demands, which may lead to high processing latency and suboptimal performance. In the present disclosure, an innovative machine-learning-based task scheduling method tailored is provided for Apache Storm. The method may leverage machine learning models to predict task performance and assign task to the computation node with the lowest predicted processing latency. Each node may operate a machine-learning-based monitoring mechanism. When a master node schedules a new task, the master node may query computation nodes to obtain corresponding available resources, and process latency predictions to make optimal assignment decision. Three machine learning models, including Long Short-Term Memory (LSTM), Convolutional Neural Networks (CNN), and Deep Belief Networks (DBN) are evaluated. LSTM is shown to achieve the most accurate latency predictions. Evaluation results demonstrate that Apache Storm with the LSTM-based scheduling method may significantly improve task processing delay and resource utilization, compared to existing approaches.

To address the challenges posed by large-scale data processing tasks, the open-source Apache Storm framework may be employed as the platform in the present disclosure. Apache Storm is an open-source framework designed for distributed systems, which may offer real-time data streaming processing and reliable handling of unbounded data streams. With Apache Storm, data processing occurs in real-time as data arrives, thereby ensuring timely and efficient processing of streaming data. Additionally, Apache Storm remains on standby when no data is being processed, thereby optimizing resource utilization and ensuring readiness to handle incoming data streams.

By leveraging Apache Storm, the platform in the present disclosure can effectively process large volumes of data streams in real-time, thereby enabling timely and accurate analysis for various applications. Such capability is particularly crucial for scenarios where fast decision-making is essential, such as real-time monitoring, anomaly detection, and predictive analytics.

Through the utilization of Apache Storm, the power of distributed computing may be harnessed to address the growing demand for efficient data processing in modern distributed systems.

In the present disclosure, a machine-learning-based task scheduling method tailored for Apache Storm is provided, which may address the limitations of conventional schedulers that fail to account for heterogeneity of resource availability and task demands. The method (approach) may leverage advanced machine learning processes to predict the latency performance (defined as total processing time of a task) based on current resource availability of each worker node. Such innovative scheduler may continuously monitor the resource status within the Apache Storm cluster and strategically assign tasks to the nodes that are best suited for handling, thereby optimizing latency performance. Crucially, the method may consider the influence of various resources (such as CPU and memory) on the computational delay of tasks, to ensure that tasks are allocated to nodes with sufficient resources to minimize processing times.

A notable advantage of the method (i.e., scheme or approach) may be the ability to operate effectively without requiring prior knowledge of available resources or specific demands of each task. Such dynamic adaptation may be particularly valuable in real-time applications, where data processing and resource needs can fluctuate rapidly. By continuously monitoring and adjusting to changes in the system, the scheduler provided in the present disclosure may respond promptly to varying workloads and resource availability, thereby ensuring optimal task allocation at all times.

To evaluate the efficacy of the scheduler provided in the present disclosure, a real-time object detection application is implemented on a testbed including heterogeneous worker nodes. Comparative results show that the machine-learning-based scheduler may significantly outperform the default schedulers provided by Apache Storm, thereby achieving substantial reductions in latency of the scheduled tasks. Such empirical evidence may validate that tasks scheduled based on predictive analytics can lead to markedly improved performance, particularly in heterogeneous distributed environments.

Furthermore, the task scheduling method (approach) provided in the present disclosure may be not limited to Apache Storm but may be extended to other distributed data processing frameworks. By integrating the machine-learning-based scheduler into these frame-works, it may unlock the potential for optimized resource utilization and improved performance across a wide range of applications and domains. Moreover, the task scheduling method provided in the present disclosure may exhibit remarkable flexibility, thereby allowing for seamless enhancements by incorporating additional features into predictive model. For example, the task scheduling method provided in the present disclosure may be extended to consider network link bandwidth, device power constraints, and other contextual factors that may influence task performance. Such extensibility may enable the scheduler in the present disclosure to become increasingly robust and adaptable, tailored to diverse computing environments, thereby ensuring continued effectiveness across varying operational conditions. By integrating supplementary parameters, the scheduler may deliver even more precise task allocation decisions, thereby optimizing not only for speed and efficiency but also for broader operational dynamics inherent to modern distributed systems. The adaptability of the task scheduling method may empower the method to evolve and accommodate emerging requirements, thereby offering a future-proof solution for efficient resource allocation in dynamic and heterogeneous computing landscapes.

The machine-learning-based task scheduling method provided in the present disclosure may address the critical challenge of efficient resource allocation in heterogeneous distributed systems. By leveraging predictive analytics and dynamic adaptation, the scheduler may ensure that tasks are assigned to the most suitable nodes, thereby minimizing latency and maximizing overall system performance. The desirable results obtained from evaluation experiments may demonstrate the significant benefits of this approach and pave the way for further research and development.

In the realm of distributed systems, efficient task scheduling is a critical challenge that demands effective partitioning of resources among tasks, particularly in heterogeneous environments. Task scheduling in heterogeneous distributed systems are studied, and various solutions are used to address the unique challenges posed by diverse computing environments. A latency-aware edge resource orchestration platform built upon Apache Storm is introduced. The performance and resource requirements of each task may be estimated through a process called latency estimation. Subsequently, a scheduler may leverage the latency estimations to assign tasks to the nodes that offer the best performance and resource match. Such latency-aware task scheduling method may outperform both the default scheduler and the resource-aware scheduler in Apache Storm by a margin of 25%. The default scheduler in Apache Storm may follows a round-robin approach, assigning tasks equally to machines within the cluster. This scheduler may operate under the assumption that all machines possess identical resources, making an equal distribution of tasks an efficient strategy. However, the default scheduler may fail to consider the resource availability in the underlying cluster or the resource requirements of Storm Topology during task scheduling. To address such limitation, a resource-aware scheduler may be provided to allow users to specify memory usage, heap size, and CPU usage requirements for their Topology. This scheduler may acknowledge the resource heterogeneity present in the cluster and assigns tasks to machines that match the specified resource requirements. By considering the diversity of available resources, the resource-aware scheduler may improve resource utilization and overall system performance. Another scheduler may be provided, which may first optimize Topology structure and then schedule executors on worker nodes by considering the communication traffic between components. Another scheduler operating in two steps may be provided, which may first assign executors to slots based on traffic patterns, and then allocate slots to worker nodes considering load balancing. Another adaptive online scheduler may continuously monitor system performance and dynamically reschedules task deployment at runtime to improve overall efficiency. A T-Storm scheduler may be traffic-aware, using runtime data to allocate tasks in a way that reduces both inter-node and inter-process traffic while ensuring worker node load does not exceed capacity. A P-Scheduler may employ a hierarchical graph partitioning approach to schedule tasks, which may first determine required number of nodes based on estimated load, and then assign heavy traffic task pairs to the same worker node to minimize inter-node and inter-process communication. Above-mentioned schedulers may offer various strategies to address the limitations of default scheduler and aim to improve resource utilization, reduce communication overhead, balance load across the cluster, and ultimately enhance the overall performance and efficiency of distributed stream processing in Apache Storm.

While above-mentioned schedulers offer various strategies to improve upon the limitations of the default Round-Robin scheduler in Apache Storm, the schedulers still fall short of providing a truly dynamic and accurate approach for choosing the optimal set of nodes to handle tasks. Existing schedulers, though considering factors like communication patterns, resource availability, and load balancing, may not fully capture complex interplay of variables that influence task performance in a heterogeneous distributed environment. To address such gap, there is a pressing need for a more intelligent and adaptive scheduling mechanism that can dynamically assess the state of the system, resource profiles of individual nodes, and the characteristics of incoming tasks, and then make informed decisions on task placement. Such a scheduler should be able to continuously learn and evolve, leveraging techniques like machine learning to accurately model the performance implications of different scheduling decisions. Such gap may motivate the design of the machine-learning-based scheduler for Apache Storm in the present disclosure. By harnessing the power of predictive analytics and dynamic adaptation, the scheduler provided in the present disclosure may aim to intelligently match tasks with the most suitable nodes, thereby ensuring optimal resource utilization, minimized latency, and overall system efficiency. Apache Storm may provide users with the flexibility to implement custom schedulers, thereby enabling the users to develop tailored scheduling strategies that align with specific application needs and operational constraints.

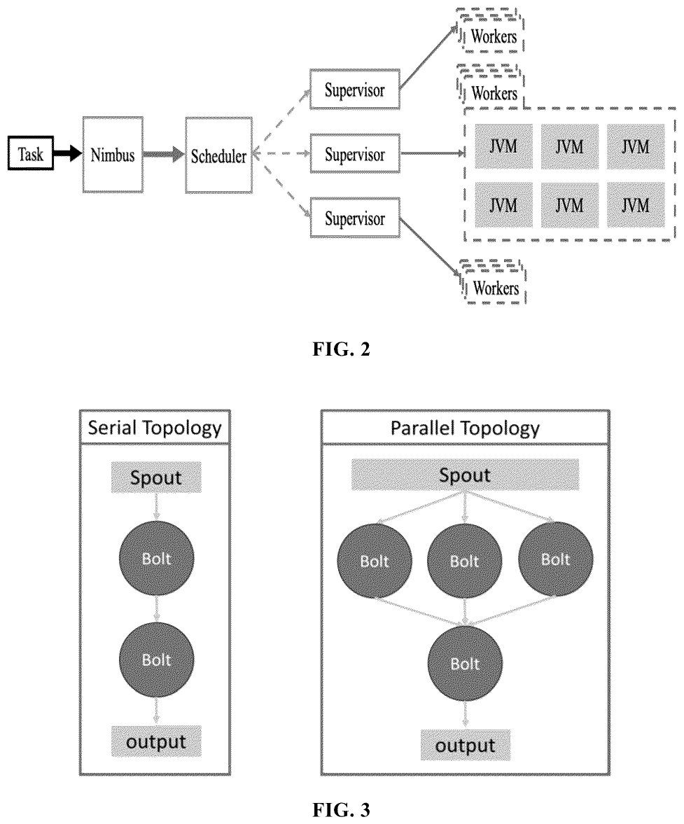

Apache Storm is a trendy distributed computing framework designed for real-time processing of data streams. The architecture of Apache Storm may include two main types of nodes: the master node (known as Nimbus) and the worker nodes (referred to as Supervisors). Nimbus may be responsible for distributing tasks across the cluster, monitoring the health of the system and managing fault tolerance. Each Supervisor node may manage one or more worker processes that execute actual computation. These workers may be capable of running multiple tasks in parallel, each in its own Java Virtual Machine (JVM), thereby allowing efficient handling of diverse operations concurrently. The tasks assigned to the workers may be based on a Topology defined by the user, which may dictate the data flow and processing logic across the cluster. The workers within one Supervisor may share resources such as CPU and memory and execute tasks either in parallel or cooperatively, depending on the configuration of the Topology. FIG. 2 depicts a schematic of an exemplary structure of Apache Storm framework according to various disclosed embodiments of the present disclosure. Referring to FIG. 2, Nimbus may receive a task and assign the task to an appropriate Supervisor via its scheduling mechanism, thereby ensuring optimal distribution of work across the available resources.

The user may configure the behavior of Apache Storm through the task Topology, which may include two main components: Spout and Bolt. Spouts may serve as sources of data streams, while Bolts may handle intermediate data processing tasks. The Topology may define the functionality and execution method for each Spout and Bolt, which may specify that whether the tasks operate in parallel or cooperatively, and how data streams flow between the Spouts and Bolts. FIG. 3 depicts a schematic of a serial topology and a parallel topology according to various disclosed embodiments of the present disclosure. FIG. 3 shows two types of the Topology: serial and parallel. In the serial Topology, Spouts and Bolts may perform different functions and operate sequentially, with each Spout/Bolt waiting for previous one to finish processing data before each Spout/Bolt begins. In contrast, Bolts in a parallel Topology may execute same function concurrently, thereby enabling faster computation by leveraging parallel processing.

Default task scheduler in Apache Storm may operate in a round-robin fashion by assigning tasks equally to the workers within the cluster without considering the diversity of available resources on each worker node. While such approach ensures an even distribution of tasks, it may fail to account for the heterogeneity of resource availability and task demands. Consequently, a machine could be assigned with multiple tasks, which may potentially lead to resource overload and increased latency if the scheduling process disregards current resource utilization levels. To address such limitation, the present disclosure provide a task scheduling method that leverages machine learning techniques to predict application latency based on resource availability. By strategically assigning tasks to the nodes with the lowest predicted latency, the method (scheme or approach) may aim to optimize resource utilization and enhance overall application performance. Through intelligent task allocation, the scheduler provided in the present disclosure may mitigate the risk of resource overload and ensure that tasks are executed on nodes with sufficient computational capacity, thereby minimizing processing delay and improving system efficiency. The fundamental principles and methodologies underpinning the solution provided in the present disclosure may enable a thorough understanding of operational mechanics and potential benefits of the solution (task scheduler).

According to various embodiments of the present disclosure, the task scheduler is described in detail hereinafter.

Apache Storm is a real-time distributed system and keeps opening and waiting for the task to be submitted. Furthermore, Apache Storm may work on multiple tasks at same time. The existing scheduler doesn't know the node's current resource availability. If a task occupies all the resources on a node, the node cannot work on another task, but the scheduler still assigns new tasks to the nodes. This problem also brings about the scheduler not knowing the task resource demand and causes the scheduler to assign the task to the node that doesn't satisfy the task resource demand.

The machine-learning-based scheduler in the present disclosure may include three components: (1) the machine learning model training; (2) the API that communicates between Nimbus (the master node) and Supervisor (the worker/leaf node); and (3) the machine-learning-based scheduler model.

According to various embodiments of the present disclosure, machine learning model training and data collection is described in detail herein. The task performance may be evaluated under different resource utilization. The features for the machine learning model to predict performance may be CPU utilization and memory usage. Above-mentioned two features may be representative of the resources on a computer. The machine learning model may predict the performance according to above features. Firstly, the performance of the task may need to be estimated. Exemplarily, real-time object detection application as the task may be implemented. The latency may be defined as the average frame processing time in a minute. The object detection application may be executed, and the latency under different CPU utilization and memory usage may be collected. Next, a Deep Neural Network (DNN) may be configured as a machine learning model. Three types of DNN models, including Long Short-Term Memory (LSTM), Convolutional Neural Networks (CNN) and Deep Belief Networks (DBN), may be evaluated. FIG. 4 depicts a schematic of comparison of Mean Squared Errors (MSEs) of three models according to various disclosed embodiments of the present disclosure. MSEs of above-mentioned DNN models are compared in FIG. 4. Referring to FIG. 4, the LSTM model may be the most accurate among these three DNN models.

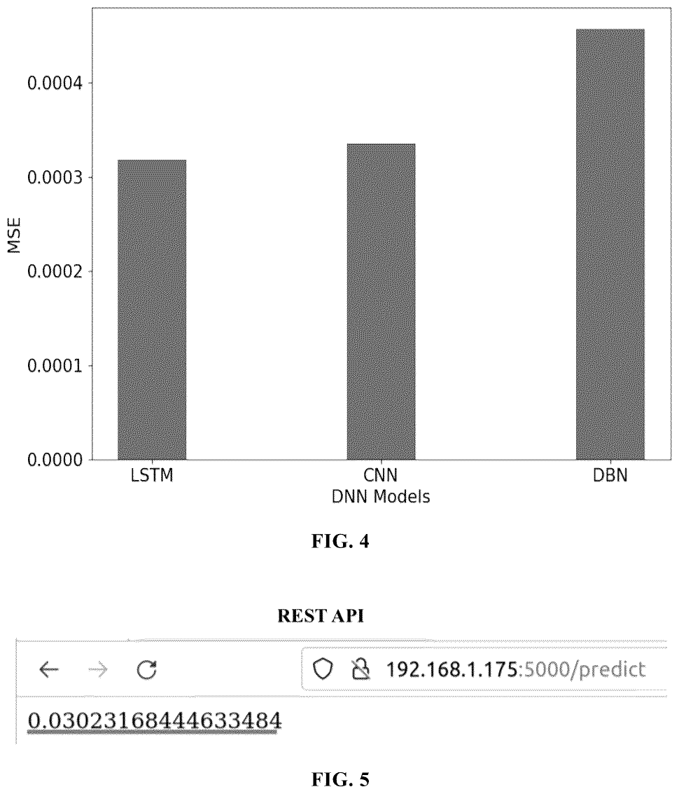

According to various embodiments of the present disclosure, a RESTful API (application programming interface) is described in detail herein. Exemplarily, the RESTful API may be configured to be the communication between Nimbus and Supervisor. The RESTful interface could allow two systems to exchange corresponding messages through the internet. The RESTful API may securely transmit the messages through HTTP. The API may be used when Nimbus needs to ask for predicted latency from the Supervisor. FIG. 5 depicts a screenshot of an exemplary RESTful API implementation according to various disclosed embodiments of the present disclosure. Referring to FIG. 5, the number at the bottom may be expected latency predicted by the Supervisor's LSTM model based on current latency.

According to various embodiments of the present disclosure, the machine-learning-based scheduler model is described in detail herein. In the method provided in the present disclosure, the Apache Storm cluster may be a heterogeneous distributed stream processing system. The nodes may have different computation capacities and resources. Therefore, the nodes may have their own machine-learning model(s) and API. The machine learning model may be trained on the node independently. The API may relate to corresponding machine-learning model. Nimbus may send requests to the Supervisor's API; and the predicted latency may be returned to Nimbus via API. Nimbus may keep opening and waiting for the task. When Nimbus receives the task, Nimbus may ask the Supervisor to predict the latency based on current CPU utilization and memory usage through the RESTful API. The predicted latency by a node may represent the performance of the task if the Nimbus schedules the task to the node. After Nimbus collects all available Supervisors' predicted latency in the cluster, the scheduler may assign the task to the node with the lowest predicted latency.

According to various embodiments of the present disclosure, testbed Design and Implementation is described in detail herein. The machine-learning-based scheduler provided in the present disclosure may be compared with Apache Storm default scheduler. The default scheduler may be in round-robin style and assume all the nodes in the cluster have same computation capacity, resources, and environment, which may indicate that equally scheduling the tasks to nodes is the most efficient method. However, the method on the heterogeneous distributed system may be implemented. Heterogeneous nodes with different computing power may be integrated into the testbed in the present disclosure. The testbed may be run on Ubuntu Linux system. The testbed may include three computers (all are Supervisors) and one Nimbus.

Different numbers of tasks, ranging from 3 to 30, may be executed simultaneously, which may help to determine how the scheduler assigned the tasks to the nodes when the available resource of the cluster is at different levels. However, the node may behave desirably when executing only one application simultaneously. If multiple applications are executed, the node might run out of all its resources and cause the application process to slow or shut down. Exemplarily, an application, real-time video object detection by YOLOv5, may be implemented. YOLOv5 (You Only Look Once, Version 5), a state-of-the-art object detection algorithm renowned for speed and accuracy, is the fifth iteration of the YOLO family of models, designed to perform real-time object detection by processing entire images in a single pass, thereby achieving rapid inference times. YOLOv5 may offer multiple improvements over predecessors, including a more efficient architecture, enhanced training techniques, and superior performance on various object detection benchmarks; and may be widely used in applications requiring fast and precise detection, such as autonomous driving, video surveillance, and augmented reality. The video may be inputted to the Supervisor which may then process the frames individually. Therefore, for the scheduler provided in the present disclosure, the LSTM model may be used to learn such application latency under different CPU utilization and memory usage. After generating the machine-learning model, the RESTful API may be properly configured in above-mentioned nodes of the cluster using corresponding IP and Port information to provide connectivity between the model and scheduling requests.

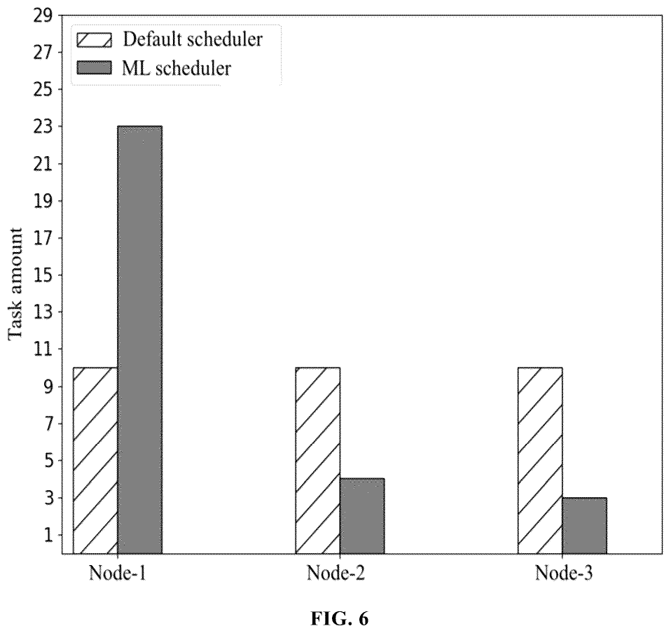

The serial Topology, featuring a single Spout and a single Bolt, may be provided in the present disclosure. The Spout's role may be crucial as the Spout handles frame processing, specifically object detection. On the other hand, the Bolt may be responsible for displaying the results. The latency measurement may be from the frame's input to the system until the object detection process is complete. In above-mentioned Topology, the Spout (i.e., entry point) and Bolt (i.e., logic container) may be assigned to separate (different) nodes. Every Topology may be independent. If the application more than once in the cluster needs to be executed, multiple Topologies may need to be submitted to Nimbus. After Nimbus receives the Topology, the scheduler may start assigning the task to the node according to the method. FIG. 6 depicts an exemplary schematic of task amount for each Supervisor (worker) node according to various disclosed embodiments of the present disclosure. FIG. 6 shows the task amount for each Supervisor node when 30 tasks (or streams) are submitted into the cluster. Referring to FIG. 6, for the default scheduler, the tasks may be assigned to three Supervisor nodes (that is, node-1, node-2 and node-3 shown in FIG. 6) equally; and for the machine-learning-based scheduler (ML scheduler) provided in the present disclosure, the tasks may be scheduled for the Supervisor nodes with desirable performance.

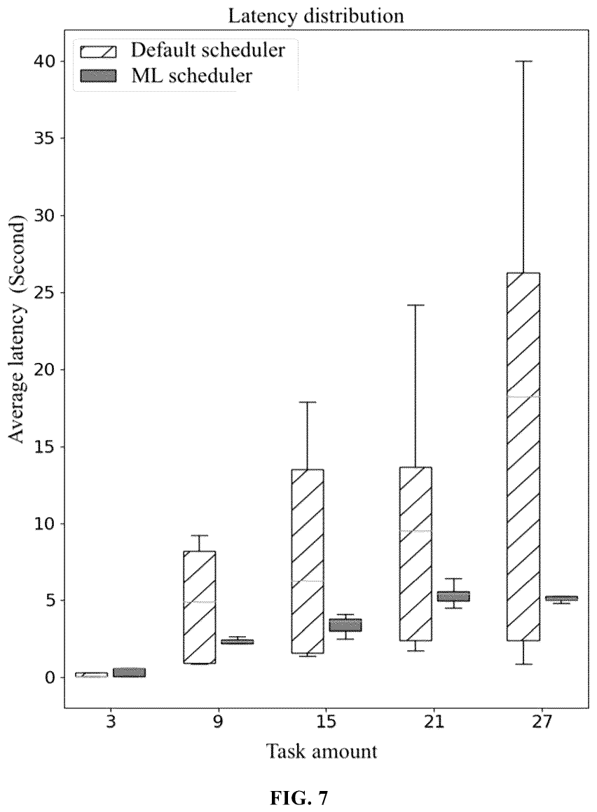

The Apache Storm default scheduler is compared with the machine-learning-based scheduler provided in the present disclosure. FIG. 7 depicts an exemplary schematic of quartiles express latency distribution according to various disclosed embodiments of the present disclosure. Firstly, the latency distribution may be observed when multiple tasks (Topology tasks) are executed, as shown in FIG. 7. FIG. 7 shows that latency distribution of the machine-learning-based scheduler (ML scheduler) provided in the present disclosure may be more stable and small-ranged. The default scheduler's latency (in seconds) may be more separated, and the maximum latency may be higher than that of a machine-learning-based scheduler's maximum latency because nodes perform the task differently. When the tasks (Topology tasks) increases, the variation between above two schedulers may be more prominent.

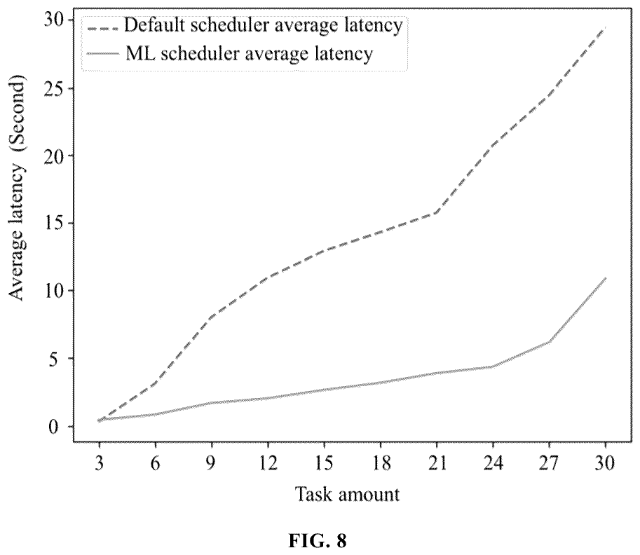

Additionally, the average latency (in seconds) of the cluster is compared when two schedulers are configured. FIG. 8 depicts an exemplary schematic of average latency for two schedulers according to various disclosed embodiments of the present disclosure. FIG. 8 shows the line graph of the average latency for two schedulers. Referring to FIG. 8, it can be seen that the dashed line, which represents the default scheduler, may be higher than the solid line, which is the machine-learning scheduler. As a result of FIG. 8, it can be seen that the machine-learning-based scheduler provided in the present disclosure may increase overall efficiency of the cluster. The machine-learning-based scheduler provided in the present disclosure may decrease latency by 60% compared to the default scheduler.

The machine-learning-based task scheduling method for Apache Storm is provided in the present disclosure. Such method may solve the problem of existing schedulers assigning tasks without considering resource availability and task demand. The machine learning may be configured to predict the task's performance, which may benefit the master node by scheduling the task on the best-performing node. The machine-learning-based scheduler may be successfully implemented in Apache Storm.

Various embodiments of the present disclosure provide an ionosphere estimation system. The system includes a memory, configured to store program instructions for performing a machine-learning-based real-time task scheduling method, applied to an Apache Storm cluster, where the Apache Storm cluster includes a master node and a plurality of worker nodes; and a processor, coupled with the memory and, when executing the program instructions, configured for: for a worker node of the plurality of worker nodes, executing a training task distributed by the master node; collecting latency time lengths of each of a plurality of machine learning models under different CPU (central processing unit) utilization and memory usage; calculating a mean squared error of the latency time lengths of each of the plurality of machine learning models; comparing the plurality of machine learning models according to mean squared errors of latency time lengths corresponding to the plurality of machine learning models to select a desirable machine learning model; and installing the desirable machine learning model on the worker node; providing an API (application programming interface) for the worker node configured for communication between the master node and the worker node; when receiving a task by the master node, requesting the worker node to predict a latency time length according to current CPU utilization and current memory usage of the worker node; and returning the predicted latency time length to the master via the API of the worker node; and after the master node collects predicted latency time lengths of the plurality of worker nodes, assigning the task to a corresponding worker node with a lowest predicted latency time length.

Various embodiments of the present disclosure provide a non-transitory computer-readable storage medium, containing program instructions for, when being executed by a processor, performing a machine-learning-based real-time task scheduling method, applied to an Apache Storm cluster, where the Apache Storm cluster includes a master node and a plurality of worker nodes. The method includes, for a worker node of the plurality of worker nodes, executing a training task distributed by the master node; collecting latency time lengths of each of a plurality of machine learning models under different CPU (central processing unit) utilization and memory usage; calculating a mean squared error of the latency time lengths of each of the plurality of machine learning models; comparing the plurality of machine learning models according to mean squared errors of latency time lengths corresponding to the plurality of machine learning models to select a desirable machine learning model; and installing the desirable machine learning model on the worker node; providing an API (application programming interface) for the worker node configured for communication between the master node and the worker node; when receiving a task by the master node, requesting the worker node to predict a latency time length according to current CPU utilization and current memory usage of the worker node; and returning the predicted latency time length to the master via the API of the worker node; and after the master node collects predicted latency time lengths of the plurality of worker nodes, assigning the task to a corresponding worker node with a lowest predicted latency time length.

Although some embodiments of the present disclosure have been described in detail through various embodiments, those skilled in the art should understand that above embodiments may be for illustration only and may not be intended to limit the scope of the present disclosure. Those skilled in the art should understood that modifications may be made to above embodiments without departing from the scope and spirit of the present disclosure. The scope of the present disclosure may be defined by the appended claims.

What is claimed is:

1. A machine-learning-based real-time task scheduling method, applied to an Apache Storm cluster, wherein the Apache Storm cluster includes a master node and a plurality of worker nodes, comprising:
for a worker node of the plurality of worker nodes, executing a training task distributed by the master node; collecting latency time lengths of each of a plurality of machine learning models under different CPU (central processing unit) utilization and memory usage; calculating a mean squared error of the latency time lengths of each of the plurality of machine learning models; comparing the plurality of machine learning models according to mean squared errors of latency time lengths corresponding to the plurality of machine learning models to select a desirable machine learning model; and installing the desirable machine learning model on the worker node;
providing an API (application programming interface) for the worker node configured for communication between the master node and the worker node;
when receiving a task by the master node, requesting the worker node to predict a latency time length according to current CPU utilization and current memory usage of the worker node; and returning the predicted latency time length to the master via the API of the worker node; and
after the master node collects predicted latency time lengths of the plurality of worker nodes, assigning the task to a corresponding worker node with a lowest predicted latency time length.

2. The method according to claim 1, wherein:
the latency time length is an average frame processing time in a minute.

3. The method according to claim 1, wherein:
the plurality of machine learning models includes Long Short-Term Memory (LSTM), Convolutional Neural Networks (CNN), and Deep Belief Networks (DBN).

4. The method according to claim 1, wherein:
the training task includes one of objection detection, location tracking, event tagging, target navigation, and model reconstruction.

5. The method according to claim 1, wherein:
the worker node manages one or more worker processes capable of running a plurality of tasks in parallel.

6. The method according to claim 1, wherein:
the Apache Storm cluster is a heterogeneous distributed stream processing system.

7. A system, comprising:
a memory, configured to store program instructions for performing a machine-learning-based real-time task scheduling method, applied to an Apache Storm cluster, wherein the Apache Storm cluster includes a master node and a plurality of worker nodes; and
a processor, coupled with the memory and, when executing the program instructions, configured for:
for a worker node of the plurality of worker nodes, executing a training task distributed by the master node; collecting latency time lengths of each of a plurality of machine learning models under different CPU (central processing unit) utilization and memory usage; calculating a mean squared error of the latency time lengths of each of the plurality of machine learning models; comparing the plurality of machine learning models according to mean squared errors of latency time lengths corresponding to the plurality of machine learning models to select a desirable machine learning model; and installing the desirable machine learning model on the worker node;
providing an API (application programming interface) for the worker node configured for communication between the master node and the worker node;
when receiving a task by the master node, requesting the worker node to predict a latency time length according to current CPU utilization and current memory usage of the worker node; and returning the predicted latency time length to the master via the API of the worker node; and
after the master node collects predicted latency time lengths of the plurality of worker nodes, assigning the task to a corresponding worker node with a lowest predicted latency time length.

8. The system according to claim 7, wherein:
the latency time length is an average frame processing time in a minute.

9. The system according to claim 7, wherein:
the plurality of machine learning models includes Long Short-Term Memory (LSTM), Convolutional Neural Networks (CNN), and Deep Belief Networks (DBN).

10. The system according to claim 7, wherein:
the training task includes one of objection detection, location tracking, event tagging, target navigation, and model reconstruction.

11. The system according to claim 7, wherein:
the worker node manages one or more worker processes capable of running a plurality of tasks in parallel.

12. The system according to claim 7, wherein:
the Apache Storm cluster is a heterogeneous distributed stream processing system.

13. A non-transitory computer-readable storage medium, containing program instructions for, when being executed by a processor, performing a machine-learning-based real-time task scheduling method, applied to an Apache Storm cluster, wherein the Apache Storm cluster includes a master node and a plurality of worker nodes; the method comprising:
for a worker node of the plurality of worker nodes, executing a training task distributed by the master node; collecting latency time lengths of each of a plurality of machine learning models under different CPU (central processing unit) utilization and memory usage; calculating a mean squared error of the latency time lengths of each of the plurality of machine learning models; comparing the plurality of machine learning models according to mean squared errors of latency time lengths corresponding to the plurality of machine learning models to select a desirable machine learning model; and installing the desirable machine learning model on the worker node;
providing an API (application programming interface) for the worker node configured for communication between the master node and the worker node;
when receiving a task by the master node, requesting the worker node to predict a latency time length according to current CPU utilization and current memory usage of the worker node; and returning the predicted latency time length to the master via the API of the worker node; and
after the master node collects predicted latency time lengths of the plurality of worker nodes, assigning the task to a corresponding worker node with a lowest predicted latency time length.

14. The storage medium according to claim 13, wherein:
the latency time length is an average frame processing time in a minute.

15. The storage medium according to claim 13, wherein:
the plurality of machine learning models includes Long Short-Term Memory (LSTM), Convolutional Neural Networks (CNN), and Deep Belief Networks (DBN).

16. The storage medium according to claim 13, wherein:
the training task includes one of objection detection, location tracking, event tagging, target navigation, and model reconstruction.

17. The storage medium according to claim 13, wherein:
the worker node manages one or more worker processes capable of running a plurality of tasks in parallel.

18. The storage medium according to claim 13, wherein:
the Apache Storm cluster is a heterogeneous distributed stream processing system.
